(19) United States
(12) Patent Application Publication
(10) Pub. No.: US 2016/0014466 A1
(43) Pub. Date: Jan. 14, 2016

(54) SEARCH FOR MEDIA MATERIAL

(71) Applicant: IPXTEND AB, Stockholm (SE)

(72) Inventors: Rickard RIBLOM, Stockholm (SE); Per LUNDBERG, Gustavsberg (SE)

(21) Appl. No.: 14/377,772

(22) PCT Filed: Feb. 6, 2013
(86) PCT No.: PCT/SE2013/050095

§ 371 Date: Aug. 8, 2014

Related U.S. Application Data
(60) Provisional application No. 61/596,753, filed on Feb. 9, 2012.

(30) Foreign Application Priority Data
Feb. 9, 2012 (SE) 1250094-8

(51) Int. Cl. H04N 21/482; G11B 27/10; H04N 21/439

(52) U.S. Cl. CPC H04N 21/4828; H04N 21/4394; G11B 27/10

(57) ABSTRACT

A method is provided to find wanted media material in a media stream that includes wanted and unwanted media material. A selected search key is a representation of a part of the wanted media material. The search is performed by searching for the search key in the media stream, by selecting a first segment of the media stream that contains the search key, by selecting at least one second segment of the media stream that contain the search key, and by comparing the first segment with the second segment. A common segment between the first and second segment is decided to be the wanted media material. The search for the wanted media material is performed in a digitally encoded domain of the media stream.

### TECHNICAL FIELD

The present invention relates to a method to find wanted media material in a media stream comprising wanted and unwanted media material, where a selected search key is a representation of a part of said wanted media material, by searching for the search key in the media stream. This is done by selecting a first segment of the media stream that contains the search key, by selecting at least one second segment of the media stream that contain the search key, and by comparing the first segment with the second segment. A common segment between the first and second segment is decided to be the wanted media material.

The present invention also relates to a device adapted to perform the inventive method, and a computer program product which, when executed by a computing device, enables the computing device to perform the steps of the inventive method.

### PRIOR ART

Patent publications WO 2002/069148 and WO 2004/019201 describes systems where a search key, which is a small sequence from a media stream, is used to find instances of the search key in a media stream, this instance indicating that the very media content that the search key is coming from is repeated again in the media stream.

For instance, if the search key is a part of a musical piece, then whenever this search key is found in the media stream the same musical piece is repeated in the media stream. The above publications shows how it is possible to repeat this in an iterative process and finding and storing many segments of the searched media content, and by comparing these different segments and extracting the part that is common between these segments, it is possible to find a final common segment that includes close to the full length version of a musical piece, or possibly even the complete full length version of the musical piece, without unwanted material such as jingles, commercial advertising, radio talkers, fading into or out of other musical pieces, bad transmission of the media signal, or other interruptions.

It is also possible that the search key represents media material that the user wants to avoid, which is searched for in order to delete this part of the media stream from a recording, such as a jingle, commercial advertising or other undesirable media content. The wanted media material is thus wanted in order to find it, isolate it and delete it from the search stream since it represents undesirable media content.

### SUMMARY OF THE PRESENT INVENTION

### Problems

The media stream is buffered to make it available for search and extraction of found segments including the search key. Any search key taken from the media stream, and segments of the media stream where the search key is found, are stored for comparison and extraction of the final wanted media material. Media material with high quality requires a lot of storage space.

The search for wanted media material, and the comparison of found segments requires a lot of computer processing capacity, and the more time it takes to process buffered media content, the more storage space is required for the media stream.

It is thus a problem to provide a more time effective way of performing the search media segments including the search key, the comparison between found media segments, and the extraction of the final wanted media material.

It is also a problem to provide a more space effective way of storing one or several search keys and the found segments.

### Solution

With the purpose of solving one or several of the above problems, and on the basis of prior art such as it has been shown above and the indicated technical field, the present invention teaches that the search for the wanted media material is performed in a digitally encoded domain of the media stream.

The encoded, also called compressed, representation of the media stream requires only a fraction of the storage space to be buffered or stored compared to the decoded, also called non-compressed, representation of the same media stream.

The digital representation also requires much less computer processing capacity to perform the search and comparison required by the invention than what is required in the processing of an non compressed representation of the media stream.

It is thus proposed that the selection of the search key, the search for and selection of the segments, the comparison of the segments, and an extraction of the wanted media material is done before decoding the media stream from the digitally encoded domain into the decoded domain.

Where a digitally encoded media stream contains an information part that can be extracted without decompressing the encoded format, which information part comprises unique information pertaining to the data in the digitally encoded media stream, it is proposed that the unique information is extracted from the media stream forming a compressed representation of the media stream.

This compressed representation required only a fraction of corresponding decoded representation in storage space, and also only a fraction of computer processing capacity to manage that the search key is selected from the compressed representation.

It is proposed that the search and comparison is made in the compressed representation, and that the full information pertaining to the wanted media material is collected from the media stream by means of the compressed representation of the wanted media material

In a more specific example of a digitally encoded media stream the stream is divided into frames of digital information, where each frame comprises a header and a body. The body comprises one information part and one data part, and the information part comprises unique information pertaining to the data in the data part.

For a media stream encoded in that way it is proposed that unique information is extracted from the media stream forming a compressed representation of the media stream, and that the search key is selected from the compressed representation, the search and comparison is made in the compressed representation, and that the full information pertaining to the wanted media material is collected from media stream by means of the compressed representation of the wanted media material.

Examples of such digital representation are the MPEG-2 Audio Layer III (MP3) format, Advanced Audio Coding (AAC) or Windows Media Audio (WMA). As an exemplifying embodiment of the present invention the media material will be exemplified as being in the MP3 format. It is then proposed that the unique information can be in the information part that represents the global gain for the frame. The global gain normally represents the audio volume strength for frames in MP3.

If the media material is in the MP3 format, then it is also possible that the unique information is the bits in the information part that represent the scale factors for the frame.

The audio stream can be a pure audio stream, the MP3 format being an example of such audio stream; however, it is nothing that prevents that the audio stream is a part of a video package stream, such as an MP4 or MPEG4 stream, which is a multiplex media stream. Normally the audio part in such multiplex media stream is relatively easy to separate from the video parts, which provides a possibility to search for wanted media material in a film stream by performing the actual search in the present audio stream.

For example, the MP3 stream can be part of a transport video package stream in MP4 format, which would provide a possibility to search for wanted media material in a video stream.

It is also possible to use different parameters from the video information of a video stream, such as unique information found in the picture header information in the video stream.

The inventive method can thus be used to search for media material in any kind of encoded media stream without decoding the media stream, such as en encoded audio stream or an encoded video stream.

Depending on the purpose of the wanted media material it is proposed that the wanted media material is extracted from the media stream and stored if it is wanted for storage, or that the wanted media material is deleted from the media stream and that the rest of the media stream is stored if it is wanted for deletion, or that the wanted media material is marked so that the wanted media material is easy to find later and then decided if it should be used, skipped, stored or deleted.

The present invention also relates to a device adapted to find wanted media material in a media stream comprising wanted and unwanted media material.

The device comprises a memory unit, a selecting unit and a comparing unit. The memory unit is adapted to store a selected search key in a first part of the memory unit, the search key being a representation of a part of the wanted media material. The selecting unit adapted to search for the search key in the media stream and to select a first segment of the media stream that contains the search key. The selecting unit is also adapted to select at least one second segment of the media stream that contain the search key. The comparing unit is adapted to compare the first segment with the second segment and to decide that the wanted media material is a common segment between the first and second segment.

It is specifically taught that the device is adapted to perform the search for the wanted media material in a digitally encoded domain of the media stream.

The device is adapted to select the search key, the selecting unit is adapted to search for and select the segments, and the comparing unit is adapted to perform the comparison of the segments and to extract the wanted media material, before a decoding unit is set to decode the media stream from the digitally encoded domain into the decoded domain.

If the digitally encoded media stream contains an information part that is extractable without decompressing the encoded format, and where the information part comprises unique information pertaining to the data in the digitally encoded media stream, it is proposed that the device comprises an extracting unit adapted to extract the unique information from the media stream forming a compressed representation of the media stream. It is then proposed that the search key is selected from the compressed representation, that the selecting unit is adapted to perform the search and selection in the compressed representation, that the comparing unit is adapted to perform the comparison in the compressed representation, and that a decoding unit is adapted to collect the full information pertaining to the wanted media material from the media stream by means of the compressed representation of the wanted media material.

One example of such encoded media stream is where the digitally encoded media stream is divided into frames of digital information, where each frame comprises a header and a body, where the body comprises one information part and one data part, and where the information part comprises unique information pertaining to the data in the data part. Is proposed above, it is then proposed that the device comprises an extracting unit adapted to extract the unique information from the media stream thus forming a compressed representation of the media stream. It is then proposed that the search key is selected from the compressed representation, that the selecting unit is adapted to perform the search and selection in the compressed representation, that the comparing unit is adapted to perform the comparison in the compressed representation, and that a decoding unit is adapted to collect the full information pertaining to the wanted media material from the media stream by means of the compressed representation of the wanted media material.

It is proposed that the device is adapted to work with a media material that is in a compressed audio format, and that the unique information is the bit in the information part that represents volume strength for the frame.

It is proposed that if the device is adapted to work with a media material that is in the MP3 format, then, as examples of possible embodiments of the present invention, the unique information can be the bit in the information part that represents the global gain for the frame, or the bits in the information part that represent the scale factors for the frame.

The audio stream can be transported as part of a video stream, such as an MP3 stream can be a part of an MP4 stream, in which case it is possible to search a film stream.

The present invention teaches that the device comprises a storage unit adapted to extract the wanted media material from the media stream and to store it in a second part of the memory unit if the purpose of the wanted media material is to store it.

It is also possible that the storage unit is adapted to delete wanted media material from the media stream and to store the rest of the media stream in a third part of the memory unit, if the purpose of the wanted media material is to delete it.

It is also possible that the device comprises a marking unit and a storage unit, where the marking unit is adapted to mark the wanted media material, and where the storage unit is adapted to store the media stream markers in a fourth part of said memory unit, providing the possibility to decide on the usage of said media stream markers later.

The present invention also relates to a computer program product comprising computer program code which, when executed by a computing device, enables the computing device to perform the steps of a method according the present invention.

The present invention also relates to a computer program readable medium upon which computer program code according to the inventive computer program product is stored.

It is proposed that the inventive computer readable medium can be any kind of readable medium, such as a wired network data transmission, a wireless data transmission, a media stream, a computer RAM-memory, or any kind of non-volatile storage device.

### Advantages

The advantages that foremost may be associated with a method, a device, a computer program product or a computer readable medium according to the present invention are that the storage of a digital representation of a media stream according to the present invention requires only a fraction of the storage space that is required for the corresponding non compressed representation of the same media content. The management of the digital representation also requires much less computer processing capacity than what is required with the corresponding non compressed representation. This enables a fast management of the media stream, which in turn means that smaller buffers are required for the media stream.

These factors together provide a fast search for wanted media material, with lower requirements of storage space and processor capacity compared to prior art.

### BRIEF DESCRIPTION OF THE DRAWINGS

A method, a device, a computer program product and a computer readable medium according to the present invention will now be described in detail with reference to the accompanying drawings, in which:

FIG. 1 shows a schematic and simplified illustration of the general method of the present invention,

FIG. 2 is a simplified illustration of a compressed representation of a coded compressed signal,

FIG. 3 is a simplified but more detailed illustration of a compressed representation of a coded compressed signal,

FIG. 4 is a simplified illustration of a video stream holding both audio material and video material

FIG. 5 is a schematic and simplified illustration of an inventive device, and

FIG. 6 is a schematic and simplified illustration of an inventive computer program product and a computer readable medium.

### DETAILED DESCRIPTION OF PREFERRED EMBODIMENTS

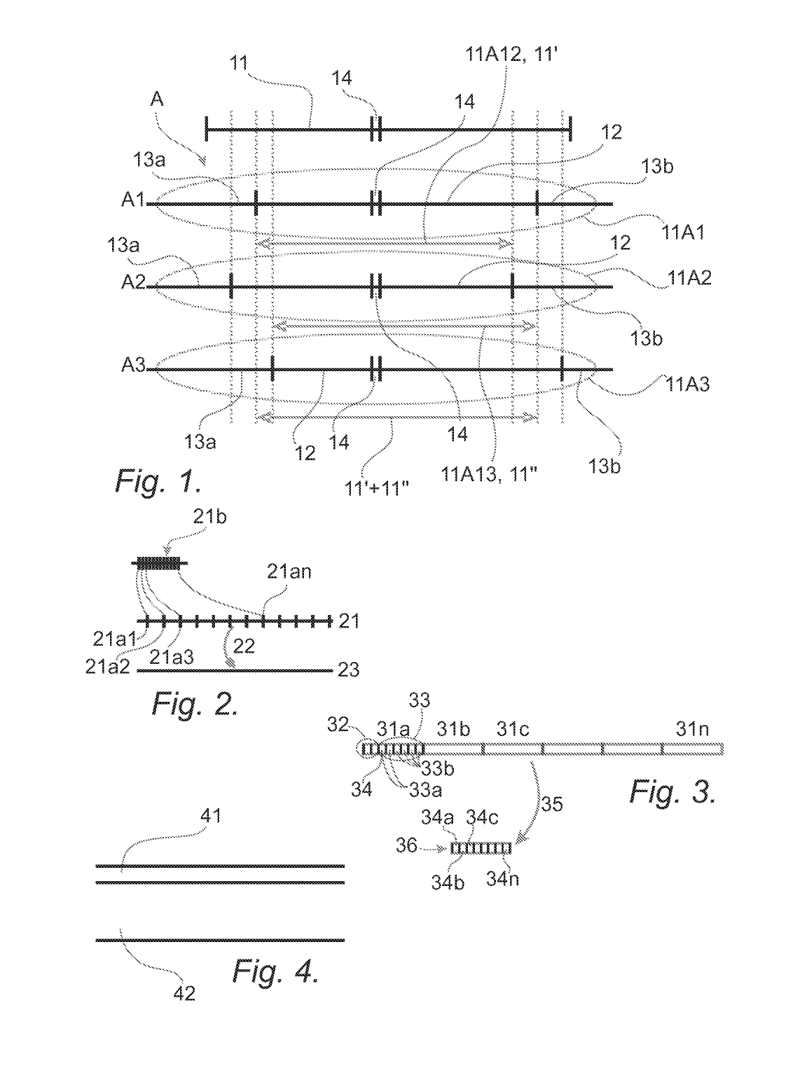

In the following, the present invention will be described with a reference to FIG. 1 illustrating a method to find wanted media material 11 in a media stream A comprising wanted 12 and unwanted 13a, 13b media material.

A selected search key 14 is a representation of a part of the wanted media material 11. This search key can be selected by a user in different ways, for example when the user is listening to music or is watching the television. How the search key is selected is not described in detail here since it is known from the prior art and the present invention is not limited to how this selection is done. However, the search key 14 represents a part of the wanted material 11, which part is big enough to uniquely identify the wanted material 11.

The invention and prior art teaches that the search key is searched for in the media stream A, where FIG. 1 shows three different parts A1, A2, A3 of the media stream where the wanted media material 11 is found.

By selecting a first segment 11A1 and at least one second segment 11A2, 11A3 of the media stream A that contain the search key 14 it is possible to compare the first segment 11A1 with the second segment 11A2 and find a common segment 11A12 between the first and second segment which is decided to be the wanted media material 11′, although it might not be all of the wanted media material 11, since part of it might be disturbed by unwanted material 13a, 13b such as jingles or commercials.

It can be seen from the figure that the common segment 11A13 between the first segment 11A1 and the other second segment 11A3 result in another part 11″ of the wanted media material 11. It is thus possible to combine the two found wanted media materials 11′, 11″ into one larger part 11′+11″ of the wanted media material 11, and by repeating this process it is possible to finally receive the full version of the wanted media material 11, it is thus shown that if several segments 11A1, 11A2, 11A3 are found and compared to each other, where a largest possible mutual common segment 11′+11″ between the several segments is decided to be the wanted media material, then this process can result in finding for example, a complete full length version of a musical piece without interruption from unwanted media material, or a complete jingle or commercial that later can be removed from the media material.

FIG. 2 shows schematically and very simplified that there are different formats or domains for the media material as it is stored, transmitted and received, decoded and finally played. In FIG. 2 a digitally encoded signal 21 is compressed and optimized for effective storage and transmission. This encoded compressed signal is decoded 22 into an uncompressed signal 23, which can be played directly, if for instance the decoded signal 23 is an analogue signal adapted to be played through loudspeakers or displayed on some kind of display unit, or it can be further transformed, if for instance the decoded signal 23 is still in a digital form that needs to be converted into an analogue form to be played. An encoded or compressed format 21 may for instance be the MP3, MP4 or MPEG4 formats while decoded or uncompressed formats 23 may be the pulse code modulation format (PCM), the waveform audio file format (WAV).

The present invention specifically teaches that the search for the wanted media material is performed in a digitally encoded domain 21 of the media stream.

It is proposed that the selection of the search key, that the search for and selection of the segments, that the comparison of the segments, and that an extraction of the wanted media material is done before decoding 22 the media stream from the digitally encoded domain 21 into a decoded domain 23.

FIG. 2 shows very simplified that with a format where the digitally encoded media stream 21 contains an information part that can be extracted without decompressing the encoded format 21, and where the information part comprises unique information 21a1, 21a2, 21a3, . . . , 21an pertaining to the data in the digitally encoded media stream 21, it is proposed that the unique information 21a1, 21a2, 21a3, . . . , 21an is extracted from the media stream 21, thus forming a compressed representation 21b of the media stream, that the search key 14 is selected from the compressed representation 21b, that the search and comparison is made in the compressed representation 21b, and that the full information pertaining to the wanted media material is collected from the media stream 21 by means of the compressed representation 21b of the wanted media material.

FIG. 3 shows an example where the digitally encoded media stream 31 is divided into frames 31a, 31b, 31c, . . . , 31n of digital information, where each frame 31a comprises a header 32 and a body 33, where the body 33 comprises one information part 33a and one data part 33b, and where the information part 33a comprises unique information 34 pertaining to the data in the data part 33b. FIG. 3 is a very simplified representation of a frame made only to illustrate this embodiment of the invention, where a frame 31a is represented by 8 bits, the header 32 by two bits, the body 33 by 6 bits, the information part 33a in the body by two bits, the data part 33b in the body by four bits, and the unique information 34 by only one bit. The present invention teaches that the unique information 34 is extracted 35 from the media stream 31 forming a compressed representation 36 of the media stream 31, which compressed representation 36 only holds the unique information bits 34a, 34b, 34c, . . . , 34n from the different frames 31a, 31b, 31c, . . . , 31n in the encoded media stream 31.

It can be understood that this very compressed representation 36 requires much less storage space and can be used for searches with much less computing power that if the corresponding compressed format 31, 21 or even uncompressed format 23 should be used.

It is thus proposed that the search key is selected from the compressed representation 36, that the search and comparison is made in the compressed representation 36, and that the full information pertaining to the wanted media material is collected from the media stream 31 by means of the compressed representation 36 of the wanted media material, which means that the media steam A in FIG. 1 is in the form of a compressed representation 36.

One example where the digitally encoded media stream 31 is divided into frames 31a, 31b, 31c, . . . , 31n is where the media material is in a compressed audio format, in which case the unique information 34 can be the bit in the information part that represents volume strength for the frame, such as if the media material is in the MP3 format, in which case the unique information 34 can be the bit in the information part 33a that represents global gain for one or more frames.

Where the media material is in a compressed audio format, it is also possible to use the unique information 34 that is the bits that represent scale factors for the frame 31a.

FIG. 4 shows that regardless of the format for the audio sound stream 41, it is also proposed that if the audio stream 41 is transported as part of a video stream 4 holding audio material 41 and video material 42, then the invention can be used on the video stream 4 via the audio stream 41.

Depending on what the purpose of finding the wanted media material is, it is proposed that once the wanted media material 11′ has been found the present invention teaches that the wanted media material 11′ is extracted from the media stream A and stored, or that the wanted media material 11′ is deleted from the media stream A and that the rest of the media stream A is stored, or that the wanted media material 11′ is marked and that the usage of selected media stream markers is decided later.

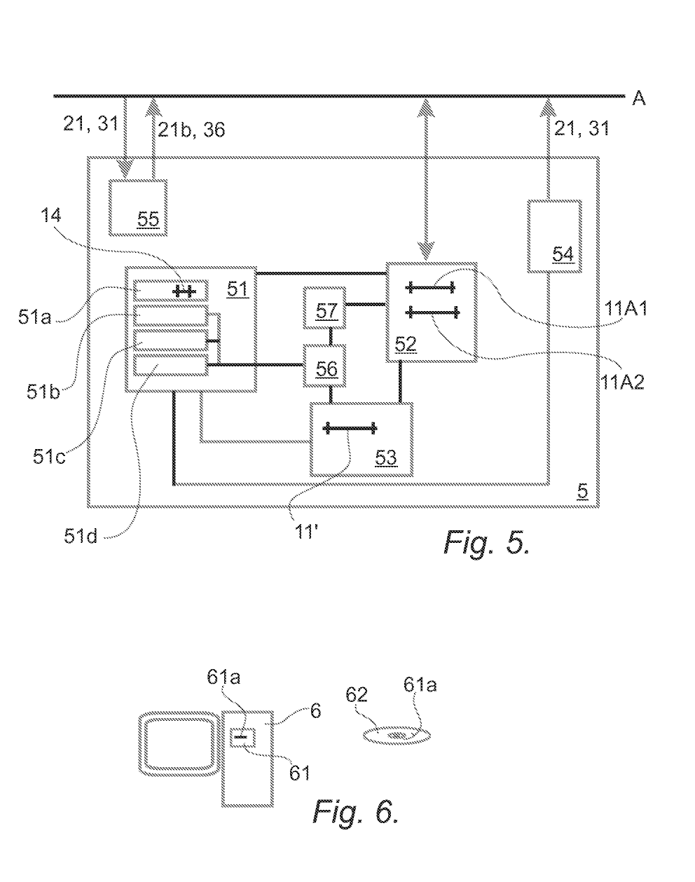

FIG. 5, with renewed reference to FIG. 1, shows that the present invention also relates to a device 5 adapted to find wanted media material 11 in a media stream A comprising wanted 12 and unwanted 13a, 13b media material.

The inventive device 5 comprises a memory unit 51, a selecting unit 52 and a comparing unit 53. The memory 51 unit is adapted to store a selected search key 14 in a first part 51a of the memory unit 51, the search key 14 being a representation of a part of the wanted media material 11. The selecting unit 52 is adapted to search for the search key 14 in the media stream A and to select a first segment 11A1 of the media stream A that contains the search key 14. The selecting unit 52 is also adapted to select at least one second segment 11A2, 1A3 of the media stream A that contain the search key 14. The comparing unit 53 is adapted to compare the first segment 11A1 with the second segment 11A2, and the comparing unit is adapted to decide that the wanted media material 11 is a common segment 11′ between the first and second segment 11A1, 11A2.

With renewed reference to FIG. 2 it is specifically proposed that the device 5 is adapted to perform the search for the wanted media material in a digitally encoded domain 21 of the media stream A.

It is also proposed that the device 5 is adapted to select the search key 14, that the selecting unit 52 is adapted to search for and select the segments 11A1, 11A2, 11A3, and that the comparing unit 53 is adapted to perform the comparison of the segments 11A1, 11A2, 11A3 and to extract the wanted media material 11′, before a decoding unit 54 is set to decode 22 the media stream A from the digitally encoded domain 21 into a decoded domain 23.

If the digitally encoded media stream 21 contains an information part 21a1, 21a2, 21a3, . . . , 21an that is extractable without decompressing the encoded format 21, where the information part 21a1, 21a2, 21a3, . . . , 21an comprises unique information pertaining to the data in the digitally encoded media stream 21, then it is proposed that an extracting unit 55 is adapted to extract the unique information 21a1, 21a2, 21a3, . . . , 21an from the media stream 21 and to form a compressed representation 21b of the media stream 21. It is then proposed that the search key 14 is selected from the compressed representation 21b, that the selecting unit 52 is adapted to perform the search and selection in the compressed representation 21b, that the comparing unit 53 is adapted to perform the comparison in the compressed representation 21b, and that a decoding unit 54 is adapted to collect the full information pertaining to the wanted media material from the media stream by means of the compressed representation 21b of the wanted media material.

As illustrated in FIG. 3 it is proposed that if the digitally encoded media stream 31 is divided into frames 31a, 31b, 31c, . . . , 31n of digital information, where each frame 31a comprises a header 32 and a body 33, where the body 33 comprises one information part 33a and one data part 33b, and where the information 33a part comprises unique information 34 pertaining to the data in the data part 33b, then it is proposed that an extracting unit 55 is adapted to extract 35 the unique information 34a, 34b, 34c, . . . , 34n from the media stream 31 forming a compressed representation 36 of the media stream 31. It is then proposed that the search key 14 is selected from the compressed representation 36, that the selecting unit 52 is adapted to perform the search and selection in the compressed representation 36, that the comparing unit 53 is adapted to perform the comparison in the compressed representation 36, and that a decoding unit 54 is adapted to collect the full information pertaining to the wanted media material from the media stream 31 by means of the compressed representation 36 of the wanted media material.

If for example the encoded media stream 31 divided into frames 31a, 31b, 31c, . . . , 31n is in a compressed audio format, then it is proposed the unique information 34 is the bit in the information part 33a that represents volume strength for the frame 31a, such as, if the media material is in the MP3 format, the unique information 34 is the bit in the information part 33b that represents the global gain for the frame 31a.

According to another possible embodiment if the digitally encoded media stream is divided into frames 31a, 31b, 31c, . . . , 31n of digital information, as described above, it is proposed that the device is adapted to work with media material that is in a compressed audio format, and that the unique information 34 is the bits that represent scale factors for the frame 31a.

It should be understood that the audio stream 41 can be transported as part of a video stream 4, as illustrated in FIG. 4.

The present invention proposes that the device comprises a storage unit 56 adapted to extract the wanted media material from the media stream and to store it in a second part 51b of the memory unit 51.

According to another embodiment the device comprises a storage unit 56 is adapted to delete the wanted media material from the media stream and to store the rest of the media stream in a third part 51c of the memory unit 51.

It is also possible that the device comprises a marking unit 57 and a storage unit 56, where the marking unit 57 is adapted to mark the wanted media material 11′, and that the storage unit 56 is adapted to store the media stream markers in a fourth part 51d of the memory unit 51, providing the possibility to decide on the usage of the media stream markers later.

FIG. 6 is a schematic illustration of an inventive computer program product 61 comprising computer program code 61a, which, when executed by a computing device 6, enables the computing device 6 to perform the steps of an inventive method as described above.

The present invention also relates to a computer program readable medium 62 upon which inventive computer program code 61a is stored, which computer readable medium 62 can be any kind of computer readable medium, such as a non-volatile storage device, even though it is illustrated as a compact disc in the figure.

It will be understood that the invention is not restricted to the aforedescribed and illustrated exemplifying embodiments thereof and that modifications can be made within the scope of the invention as defined by the accompanying

1. Method A method to find wanted media material in a media stream comprising wanted and unwanted media material, where a selected search key is a representation of a part of said wanted media material, said method comprising the steps of:
searching for said search key in said media stream;
selecting a first segment of said media stream that contains said search key;
selecting at least one second segment of said media stream that contain said search key;
comparing said first segment with said second segment; and
where a common segment between said first and second segment is decided to be said wanted media material, performing the search for said wanted media material in a digitally encoded domain of said media stream,
wherein said selection of said search key, said search for and selection of said segments, said comparison of said segments, and an extraction of said wanted media material is done before decoding said media stream from the digitally encoded domain into a decoded domain,
wherein said digitally encoded media stream is divided into frames of digital information,
wherein each frame comprises a header and a body,
wherein said body comprises one information part and one data part,
wherein said information part comprises unique information pertaining to the data in said data part,
wherein said unique information is extracted from said media stream forming a compressed representation of said media stream,
wherein said search key is selected from said compressed representation,
wherein said search and comparison is made in said compressed representation, and
wherein the full information pertaining to said wanted media material is collected from said media stream by means of said compressed representation of said wanted media material.

2. The method according to claim 1, wherein said media material is in a compressed audio format, and the unique information is the bit in said information part that represents volume strength for said frame.

3. The method according to claim 2, wherein said media material is in the MP3 format, and the unique information is the bit in said information part that represents global gain for one or more frames.

4. The method according to claim 1, wherein said media material is in a compressed audio format, and the unique information is the bits that represent scale factors for said frame.

5. The method according to claim 2, wherein said audio stream is transported as part of a video stream.

6. The method according to claim 1, wherein wanted media material is extracted from the media stream and stored.

7. The method according to claim 1, wherein wanted media material is deleted from the media stream and the rest of the media stream is stored.

8. The method according to claim 1, wherein wanted media material is marked and that the usage of selected media stream markers is decided later.

9. A device adapted to find wanted media material in a media stream comprising wanted and unwanted media material, said device comprising:
a memory unit.
a selecting unit; and
a comparing unit,
wherein said memory unit is adapted to store a selected search key in a first part of said memory unit, said search key being a representation of a part of said wanted media material,
wherein said selecting unit is adapted to search for said search key in said media stream and to select a first segment of said media stream that contains said search key,
wherein said selecting unit is adapted to select at least one second segment of said media stream that contain said search key, and
wherein said comparing unit is adapted to compare said first segment with said second segment, and
where said comparing unit is adapted to decide that said wanted media material is a common segment between said first and second segment, said device is adapted to perform the search for said wanted media material in a digitally encoded domain of said media stream,
wherein said device is adapted to select said search key,
wherein said selecting unit is adapted to search for and select said segments,
wherein said comparing unit is adapted to perform said comparison of said segments and to extract said wanted media material, before a decoding unit is set to decode said media stream from the digitally encoded domain into a decoded domain,
wherein said digitally encoded media stream is divided into frames of digital information,
wherein each frame comprises a header and a body,
wherein said body comprises one information part and one data part,
wherein said information part comprises unique information pertaining to the data in said data part,
wherein an extracting unit is adapted to extract said unique information from said media stream forming a compressed representation of said media stream,
wherein said search key is selected from said compressed representation,
wherein said selecting unit is adapted to perform said search and selection in said compressed representation,
wherein said comparing unit is adapted to perform said comparison in said compressed representation, and
wherein a decoding unit is adapted to collect the full information pertaining to said wanted media material from said media stream by means of said compressed representation of said wanted media material.

10. The device according to claim 9, wherein said device is adapted to work with a media material that is in a compressed audio format, and the unique information is the bit in said information part that represents volume strength for said frame.

11. The device according to claim 10, wherein said device is adapted to work with a media material that is in the MP3 format, and the unique information is the bit in said information part that represents the global gain for said frame.

12. The device according to claim 9, wherein said device is adapted to work with media material that is in a compressed audio format, and the unique information is the bits that represent scale factors for said frame.

13. The device according to claim 9, wherein said audio stream is transported as part of a video stream.

14. The device according to claim 9, wherein said device comprises a storage unit adapted to extract said wanted media material from said media stream and to store it in a second part of said memory unit.

15. The device according to claim 9, wherein said device comprises a storage unit adapted to delete said wanted media material from the media stream and to store the rest of the media stream in a third part of said memory unit.

16. The device according to claim 9, wherein said device comprises a marking unit and a storage unit, said marking unit is adapted to mark said wanted media material, and said storage unit is adapted to store said media stream markers in a fourth part of said memory unit, providing the possibility to decide on the usage of said media stream markers later.

17. A computer program product embodied on a non-transitory computer readable medium and comprising computer program code, wherein said computer program code, when executed by a computing device, enables said computing device to perform the steps of the method according to claim 1.

18. (canceled)

19. according to claim 18, wherein said non-transitory computer readable medium is a non-volatile storage device.

20. The method according to claim 3, wherein said audio stream is transported as part of a video stream.

21. The method according to claim 3, wherein said audio stream is transported as part of a video stream.
